(19) United States
(12) Patent Application Publication
(10) Pub. No.: US 2003/0147245 A1
(43) Pub. Date: Aug. 7, 2003

(54) Structure of a mini lamp

(76) Inventor: Ching Shui Chen, Taipei (TW)

Correspondence Address: Ching Shui Chen, PO Box 82-144, Taipei, TW

(21) Appl. No.: 10/060,356

(22) Filed: Feb. 1, 2002

(51) Int. Cl. F21V 3/00

(52) U.S. Cl. 362/363; 362/353; 362/800; 362/293; 362/231

(57) ABSTRACT

A mini lamp is disclosed. The mini lamp of the present invention comprises a lamp head, a lampshade, a power source circuit component, a circuit and LED. The mini lamp is connected to the lamp head by means of the lamp seat and the mini lamp is connected to the power source. The lampshade covers the power source circuit component and the combination of circuit and LED components, and the internal components are protected. The power source circuit component is soldered on the lamp head and the bottom lampshade. The circuit and LED components comprise IC and a plurality of LEDs. The IC controls LED so as to provide colorful flickering of light.

### BACKGROUND OF THE INVENTION

(a) Field of the Invention

The present invention relates to an improved structure of a mini lamp, and in particular, to a mini lamp which provides multi-colored flickering light effect.

(b) Description of the Prior Art

Generally, conventional lamp provides only a single colored effect. For instance, tungsten light bulb provides a light effect close to yellow color. If the light is to be changed to other color, paints or the likes with color is applied to the lampshade of the lamp, however, only one color can be obtained with such color coating.

### SUMMARY OF THE INVENTION

Accordingly, it is an object of the present invention to provide an improved structure of a mini lamp, wherein a single colored light or a multiple colored light can be obtained so as to create impressive color-light effect to the environment.

Yet a further object of the present invention is to provide an improved structure of a mini lamp, wherein the lamp comprises a lamp head, a lampshade, a power source circuit component, a circuit and LED. The mini lamp is connected to the lamp head by means of the lamp seat and the mini lamp is connected to the power source. The lampshade covers the power source circuit components and the combination of circuit and LED components, and the internal components are protected. The power source circuit component is soldered onto the lamp head and the bottom lampshade. The circuit and LED components comprise IC (integrated circuit) and a plurality of LEDs. The IC controls LED so as to provide colorful flickering of light.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a mini lamp in accordance with the present invention.

FIG. 2 is another perspective exploded view of the mini lamp in accordance with the present invention.

FIGS. 3 to 5 show flowcharts of the mini lamp in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

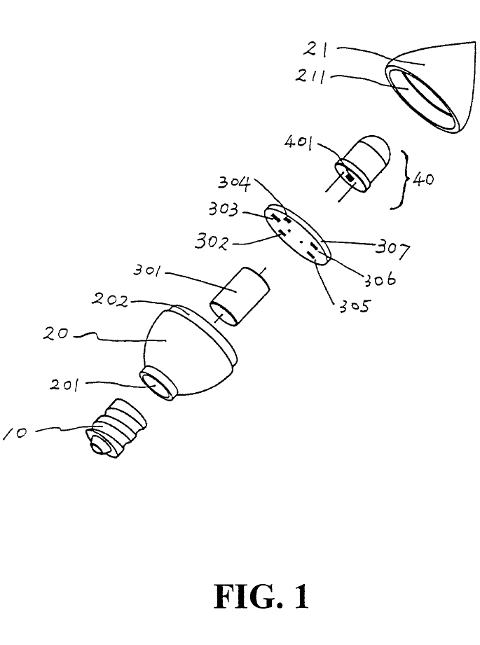

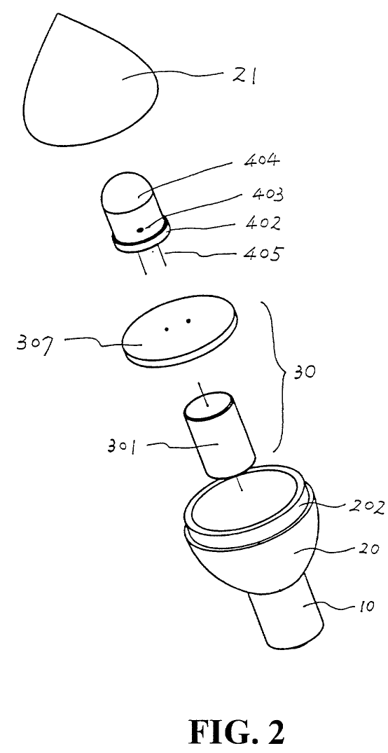

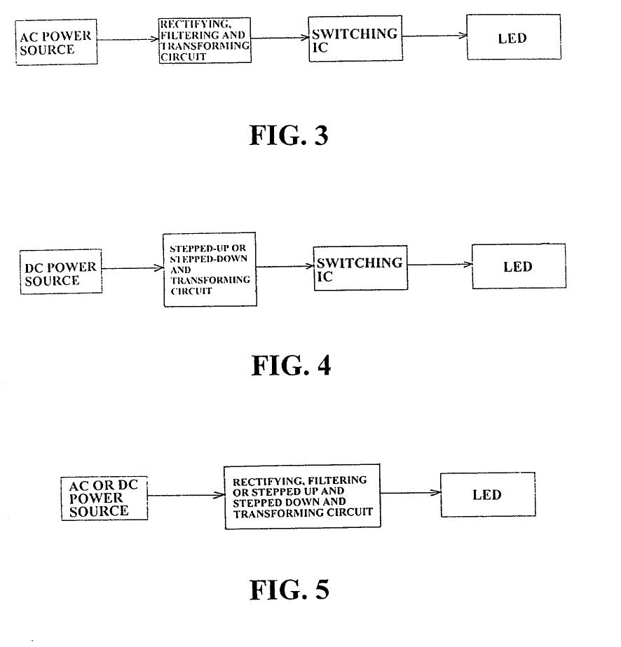

Referring to FIGS. 1 and 2, there is shown a mini lamp in accordance with the present invention. The mini lamp is fixed onto a lamp seat. The mini lamp has a lampshade including a bottom lampshade 20 and a top lampshade. The bottom lampshade 20 is a thistle funnel shape and the bottom center of the lampshade 20 is provided with a notch 201 for the mounting of a power source circuit module and the connection of the circuit. In the course of assembly, the lampshade is directly mounted onto the lamp head. The external edge of the opening at the upper side is a circular engraved slot 202. The top lampshade 21 is a circular conic shape and has a bottom edge being provided with a circular engraved slot 211. As the top and bottom lampshade are provided with engraved slots, both can be combined by adhesion. The power source circuit module 30 includes electronic components 301, 302, 303, 304, 305, 306 and the printed circuit board 307. The flowchart of the circuit is shown in FIGS. 3 and 4. When AC power source is applied to the mini lamp of the present invention, as shown in FIG. 3, the AC is first rectified and filtered and then is proceeded to transformation so as to provide a stable DC source for utilization by the circuit and the LED components. When DC power source is applied to the mini lamp of the present invention, as shown in FIG. 4, the DC is either stepped up or stepped down or directly provided with current for the utilization of the circuit and the LED components. The circuit and the LED components 40 comprise IC 401, printed circuit board 402, one or more than one LED 403 and a transparent formed plastic material 404 or plastic material 404 with other pigments. The IC 401 is soldered onto one surface of the PCB (printed circuit board), and a LED 403 is positioned on the other side of the printed circuit board 402, the connection wires pass through the printed circuit board 402 being used as electrical connection. IC 401 provides various kinds of switching from electrical energy, and LED 403 converts the switched electrical energy into light energy. The light produced by LED 403 radiates out through the formed plastic body 404 and the top lampshade 21. The material of the top lampshade and the formed plastic body 404 is a transparent material or translucent material having light-mixing effect. The material used is dependent on the need and the venue of application.

When assemble the components of the mini lamp of the present invention, the LED 403 is soldered onto the printed circuit board 402 and then the integrated circuit (IC) 401 is soldered onto one surface of the printed circuit board 402, after a lead wire 405 is provided, proceeds to a molding and a de-molding process until a circuit and a LED component 40 are obtained. Next, proceed to the fabrication of a power source circuit component 30, and the circuit and the LED component 40 and the power source circuit component 30 are combined. The third step is the adhesion of the two modules together with the bottom lampshade 20 and the lamp head 10. The final stage is that the top lampshade 21 covers the adhered bottom lampshade 20 there under.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A structure of a mini lamp comprising:
(a) a lamp head screwed onto or engaged onto a lamp seat and connected to a power source;
(b) a lamp shade having a top and a bottom section and enclosed a power source circuit component and circuit and LED component;
(c) the power source circuit component providing stable power source to the circuit and for utilization of the LED components, and
(d) the circuit and LED component to convert electrical energy to switching action and convert to light.

2. The structure of a mini lamp of claim 1, wherein the lamp head is provided with screw threads.

3. The structure of a mini lamp of claim 1, wherein the lamp head is a smooth cylindrical body having two protruded peg structures.

4. The structure of a mini lamp of claim 1, wherein the lamp shade is made from a transparent plastic material.

5. The structure of a mini lamp of claim 1, wherein the lamp shade is made from translucent material having color mixing function.

6. The structure of a mini lamp of claim 1, wherein the power source circuit component includes electronic parts, applicable in AC power source.

7. The structure of a mini lamp of claim 1, wherein the power source circuit component includes electronic parts, applicable in PC power source.

8. The structure of a mini lamp of claim 1, wherein the circuit and the LED component include IC, LED and formed plastic body.

9. The structure of a mini lamp of claim 1, wherein the circuit and the LED component include LED and formed plastic body.

10. The structure of a mini lamp of claim 1, wherein the LED in the circuit and LED component comprises a single LED or a plurality of LEDs.

11. The structure of a mini lamp of claim 1, wherein the LED in the circuit and LED component comprises of single colored LED or multiple colored LEDs.
